(19) United States
(12) Patent Application Publication
(10) Pub. No.: US 2004/0205255 A1
(43) Pub. Date: Oct. 14, 2004

(54) Carabiner electronic data device

(75) Inventor: David Joachim, Bridgewater, NJ (US)

Correspondence Address: Richard S. Roberts, Roberts & Mercanti, L.L.P., P.O. Box 484, Princeton, NJ, 98542, US

(73) Assignee: ROYAL CONSUMER INFORMATION PRODUCTS, INC.

(21) Appl. No.: 10/412,810

(22) Filed: Apr. 11, 2003

(51) Int. Cl. G06F 3/00

(52) U.S. Cl. 710/1

(57) ABSTRACT

A hand held electronic data device which may conveniently be clipped onto a belt loop, purse strap, keychain, hook, or the like. The device includes a housing having a substantially planar base and a substantially planar carabiner clip assembly which is unitary with the base. A data input component is present on an exterior surface of the base. This data input component is capable inputting data and/or function commands into a microprocessor which is contained within the housing. A data display is also present on another portion of the exterior surface of the base, which data display serves to visually display data from the microprocessor.

### BACKGROUND OF THE INVENTION

1. Field of the Invention

The present invention relates to portable electronic data devices. More particularly, the invention relates to an electronic data device, such as a calculator, with a built-in carabiner clip assembly.

2. Description of the Related Art

Portable data processing devices that assist with processing and information needs include personal digital assistants (PDAs), calculators, data organizers, and the like. PDA's are small devices, typically smaller than a notebook computer, which store personal information and also may serve as an interface to communications. They typically include a means for data input, a data processing means, a display, and optional telecommunications capabilities. PDAs, which are much more convenient to use than computers, are often characterized by a relatively large touch sensitive screen which serves as both the input and output interface.

Many electronic data devices are manufactured to be smaller yet than PDA's, and are able to receive, store, process, and display various types of numeric and alphanumeric information. Typically, they are used for performing numeric functions and/or keeping track of phone numbers, addresses, appointments, and the like. While such data devices can be thought of as computers, they hold a separate niche in the market because of their smaller size and special operating system.

Such electronic data devices are typically small enough to fit in a purse or briefcase. However, they are often clumsy or burdensome objects to carry when a user is not holding a purse or briefcase. It would therefore be desirable to provide an electronic data organizer or numeric calculator which is convenient for users to carry anywhere, at any time. The present invention provides a solution to this problem.

The invention relates to a hand held electronic data device which may conveniently be clipped onto a belt loop, purse strap, keychain, hook, or the like. The inventive device includes a housing having a substantially planar base and a substantially planar carabiner clip assembly which is unitary with the base. A data input component is present on an exterior surface of the base. This data input component is capable inputting data and/or function commands into a microprocessor which is contained within the housing. A data display is also present on another portion of the exterior surface of the base, which data display serves to visually display data from the microprocessor.

### SUMMARY OF THE INVENTION

The invention provides a hand held electronic data device comprising: a housing comprising a base and a carabiner clip assembly unitary with the base; the base having an exterior surface; a data input component on a portion of the exterior surface of the base for inputting data and function commands into a microprocessor; and a data display on a portion of the exterior surface of the base for displaying data from said microprocessor.

The invention further provides a calculator which comprises: a housing comprising a base and a carabiner clip assembly unitary with the base; the base having an exterior surface; a data input component on a portion of the exterior surface of the base for inputting numeric data and numeric function commands into a microprocessor; and a data display on a portion of the exterior surface of the base for displaying data from said microprocessor.

The invention still further provides a method for processing data which comprises:

a) providing a hand held electronic data device which comprises:

a housing comprising a base and a carabiner clip assembly unitary with the base; the base having an exterior surface; a data input component on a portion of the exterior surface of the base for inputting data and function commands into a microprocessor; and a data display on a portion of the exterior surface of the base for displaying data from said microprocessor;

b) inputting data and function commands into the microprocessor via the data input component;

c) processing the entered data via the microprocessor; and

d) displaying the processed data via the data display.

The invention yet further provides a method for calculating numeric values which comprises:

a) providing a calculator which comprises: a housing comprising a base and a carabiner clip assembly unitary with the base; the base having an exterior surface; a data input component on a portion of the exterior surface of the base for inputting numeric data and numeric function commands into a microprocessor; and a data display on a portion of the exterior surface of the base for displaying data from said microprocessor;

b) inputting numeric data and numeric function commands into the microprocessor via the data input component;

c) processing the entered numeric data via the microprocessor; and

d) displaying the processed data via the data display.

### BRIEF DESCRIPTION OF THE DRAWINGS

FIG. 1 shows a front perspective view of a hand held electronic data device of the invention.

FIG. 2 shows a side view of a hand held electronic data device of the invention.

FIG. 3 shows a rear view of a hand held electronic data device of the invention.

### DETAILED DESCRIPTION OF THE PREFERRED EMBODIMENT

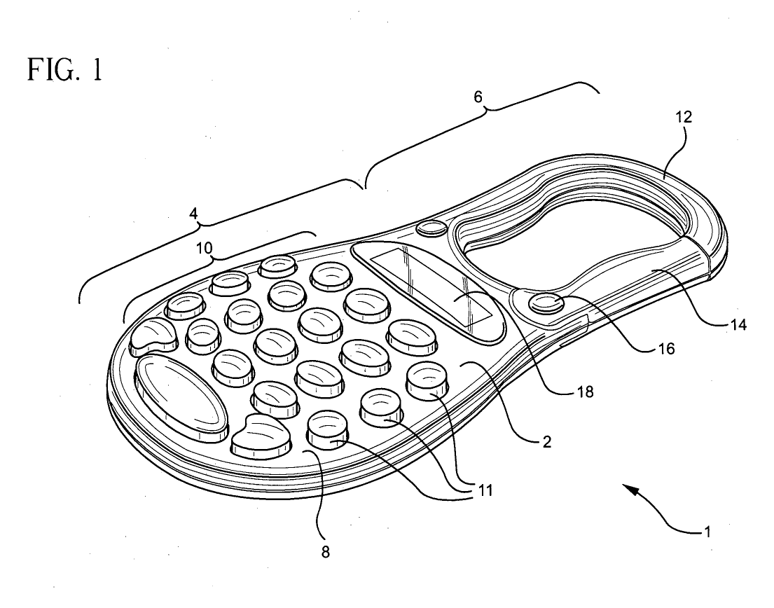

The invention provides a hand held electronic data device, such as a calculator, which is shown in FIGS. 1, 2, and 3. These figures show a front, side, and rear view, respectively, of a hand held electronic data device 1 of the invention. A housing 2 is shown having a substantially planar base 4 and a substantially planar carabiner clip assembly 6, which is unitary with the base 4.

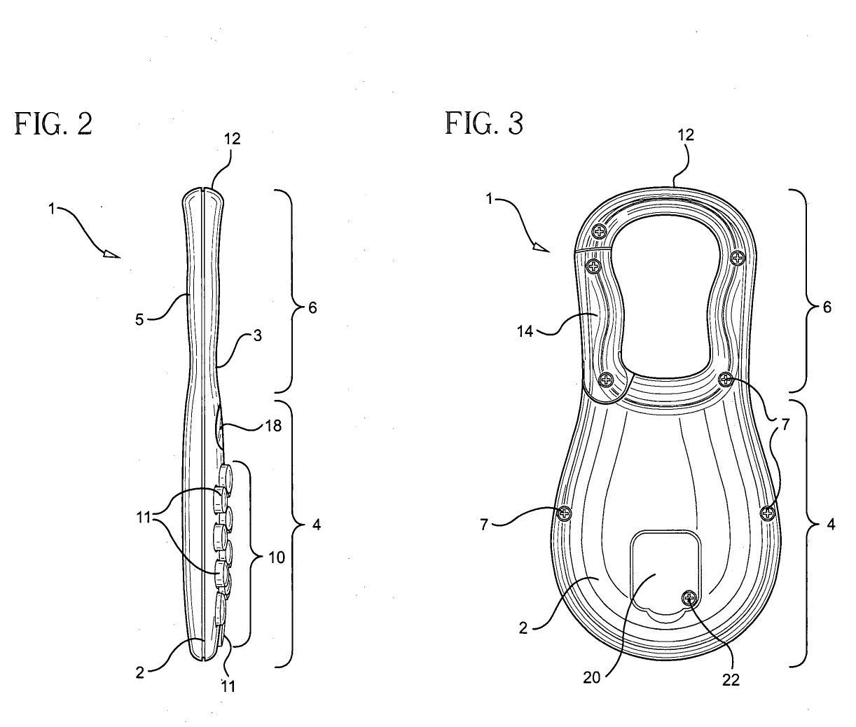

The housing 2 serves as a protective structure for encasing various internal components of the invention such as a microprocessor, calculator chip, electronic circuitry, display backlighting, and the like. The housing 2 may comprise plastic, metal, rubber, and the like, or combinations thereof, or any other material which one skilled in the art may deem suitable for forming a protective structure. In a preferred embodiment, the housing comprises a plastic material. In one preferred embodiment, shown in FIG. 2, the housing 2 comprises front and rear housing panels 3 and 5, respectively. The panels are preferably secured together via housing fasteners 7 which preferably comprise screws or the like, as shown in FIG. 3. The housing 2 is preferably formed into a compact pocket sized shape which can comfortably fit into a user's hand.

The substantially planar base 4 has a substantially planar exterior surface 8. As shown in FIG. 1, a data input component 10 is present on a portion of the exterior surface 8. The data input component 10 is capable of inputting data and/or functional commands into a microprocessor which is present within the housing 2, as described below. In one preferred embodiment, the data input component 10 is capable of inputting numeric data and numeric functional commands into the microprocessor. In another preferred embodiment, the data input component 10 is capable of inputting alphanumeric data and alphanumeric functional commands into the microprocessor.

The data input component 10 may comprise any conventional data inputting means known to those skilled in the art such as a keypad, a touch screen, and the like. FIG. 1 shows one preferred embodiment where a data input component 10 comprises a keypad having least one depressible key or button 11 for inputting data into the microprocessor. In an alternate embodiment, data may be entered into the microprocessor by touching a touch screen with a pen or stylus.

A key feature of the invention is the presence of a substantially planar carabiner clip assembly 6, which is unitary with the base 4. The carabiner clip assembly 6 preferably comprises the features of a conventionally known carabiner. Such are described in detail in U.S. Pat. Nos. 4,095,316 and 5,005,266. In one preferred embodiment of the invention, shown in FIG. 1, the carabiner clip assembly 6 includes a substantially C-shaped hook 12 defining an open gap, and a spring-loaded pivoting gate 14 which spans the gap. The gate 14 has first and second ends, wherein the first gate end comprises a stop, and wherein second gate end is pivotably attached to a portion of the C-shaped hook 12 via a rivet 16 or the like, such that the spring loaded gate 14 is capable of alternately opening and closing the gap. Most preferably, the first gate end comprises a stop which forms a tongue-in-groove arrangement with an end of the C-shaped hook 12.

It is preferred that the hook 12 comprises substantially the same material as the base 4. The gate 14 may comprise a material which is the same or different from the material of the hook 12. The gate 14 preferably comprises metal or plastic. The carabiner clip assembly 6 serves to enable the electronic data device 1 of the invention to be conveniently clipped onto a belt loop, purse strap, hook, key ring, or the like, or onto any other suitable object desired by a user.

The invention further requires a data display 18 on another portion of the exterior surface 8 of the base 4, as shown in FIG. 1. The data display 18 serves to visually display data numeric and/or alphanumeric data from a microprocessor, described below. The data display 18 may comprise any known conventional means for visually displaying data, such as a black and white or color screen. In a most preferred embodiment, the data display 18 comprises a liquid crystal display (LCD) as shown in FIG. 1. Other known displays nonexclusively include light-emitting diode displays, backlighted screen displays, and the like.

A microprocessor is preferably present within the housing 2. The microprocessor is preferably electrically coupled via internal wires within the housing to the data display 18. The microprocessor serves to process data which has been entered via the data input component 10, such that the processed data may be visually displayed by the data display 18. Examples of functions which may be performed by the microprocessor nonexclusively include numeric calculator functions, graphing functions, mapping functions, data organization functions, and word functions such as word processing. The microprocessor may also be capable of spell checking, thesaurus, and language translation functions, and the like. The microprocessor, data input component, and data display are all well known in the art such as from U.S. Pat. Nos. 5,625,673, 5,818,924 and 5,548,477 which are incorporated herein by reference.

Optionally but preferably, the invention further comprises an internal data memory which is capable of receiving and storing data such as numeric data and/or alphanumeric data. If present, the data memory is preferably electrically coupled to the microprocessor via internal wires within the housing. Such data memories are well known in the art.

The microprocessor is preferably also electrically connected to an internal power source within the housing. The power source may comprise any conventional power supplying means known in the art. Preferably, the power source comprises a battery, a solar cell, a miniature fuel cell or the like. The power source preferably comprises a battery located within the housing 2, and which battery is electrically connected via internal wires to the microprocessor. FIG. 3 shows one preferred embodiment wherein the housing comprises an access door 20 which is connected to the housing via a door attachment 22 comprising a screw or the like. In a most preferred embodiment, power is supplied to the data display 18, the data input component 10, and the optional data memory, if present, from an internal battery via the microprocessor.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

1-5. (canceled)

6. The calculator of claim 11 wherein the keypad data input component is capable of inputting alphanumeric data and alphanumeric function commands into the microprocessor.

7. The calculator of claim 11 wherein the data display comprises a liquid crystal display.

8. The calculator of claim 11 wherein the data display comprises a light emitting diode display.

9. (Canceled)

10. The calculator of claim 11 which is a data storage organizer.

11. A calculator which comprises: a housing comprising a base and a carabiner clip assembly unitary with the base; the base having an exterior surface; a keypad data input component on a portion of the exterior surface of the base capable of inputting numeric data and numeric calculation function commands into a microprocessor; and a data display on a portion of the exterior surface of the base for displaying data from said microprocessor.

12. (Canceled)

13. The calculator of claim 11 further comprising a touch screen data input component.

14. The calculator of claim 11 further comprising a numeric data memory which is coupled to the microprocessor.

15. A method for calculating which comprises:
a) providing a hand held electronic data device which comprises:
a housing comprising a base and a carabiner clip assembly unitary with the base; the base having an exterior surface; a keypad data input component on a portion of the exterior surface of the base capable of inputting numeric data and numeric calculation function commands into a microprocessor; and a data display on a portion of the exterior surface of the base for displaying data from said microprocessor;
b) inputting numeric data and numeric calculation function commands into the microprocessor via the keypad data input component;
c) processing the entered numeric data via the microprocessor; and
d) displaying the processed numeric data via the data display.

16. The method of claim 15 further comprising attaching the housing to an article via the carabiner clip assembly.

17. (Canceled)

18. The method of claim 15 further comprising a touch screen data input component.

19. The method of claim 15 further comprising a numeric data memory which is coupled to the microprocessor.

20. The method of claim 15 wherein the keypad data input component is capable of inputting numeric data and numeric function commands into the microprocessor.

21. The method of claim 15 wherein the data input component is capable of inputting alphanumeric data and alphanumeric function commands into the microprocessor.

22. A method for calculating numeric values which comprises:
a) providing a calculator which comprises: a housing comprising a base and a carabiner clip assembly unitary with the base; the base having an exterior surface; a keypad data input component on a portion of the exterior surface of the base capable of inputting numeric data and numeric calculation function commands into a microprocessor; and a data display on a portion of the exterior surface of the base for displaying data from said microprocessor;
b) inputting numeric data and numeric calculation function commands into the microprocessor via the keypad data input component;
c) processing the entered numeric data via the microprocessor; and
d) displaying the processed numeric data via the data display.

23. The method of claim 22 further comprising attaching the housing to an article via the carabiner clip assembly.

24. (Canceled)

25. The method of claim 22 further comprising a touch screen data input component.

26. The method of claim 22 further comprising a numeric data memory which is coupled to the microprocessor.

27. The calculator according to claim 11 wherein the housing comprises a substantially planar arcuate base and a substantially planar carabiner clip assembly which is unitary with the substantially planar arcuate base.
